(19) United States
(12) Patent Application Publication
(10) Pub. No.: US 2026/0062582 A1
(43) Pub. Date: Mar. 5, 2026

(54) CONDUCTIVE METAL FILM AND ITS MANUFACTURING METHOD

(71) Applicant: UNIVERSITY-INDUSTRY COOPERATION GROUP OF KYUNG HEE UNIVERSITY, Yongin-si (KR)

(72) Inventors: Sun Ho JEONG, Yongin-si (KR); Sang Hyeok BAE, Yongin-si (KR)

(21) Appl. No.: 19/311,857

(22) Filed: Aug. 27, 2025

(30) Foreign Application Priority Data
Aug. 27, 2024 (KR) 10-2024-0115083

(51) Int. Cl. C09D 11/52; B05D 3/06

(52) U.S. Cl. CPC C09D 11/52; B05D 3/06; B05D 2601/10

(57) ABSTRACT

A conductive metal film and a method of fabricating the same. According to embodiments of the present disclosure, even when a firing reaction is carried out by surface-treating a metal film with an organic molecule containing carboxylic acid, an oxide film is hardly formed on the metal film, and even if an oxide film is formed, it can be reduced, thereby providing a conductive metal nanoparticle film having excellent electrical conductivity and a method of fabricating the same.

### CROSS-REFERENCE TO RELATED APPLICATION

This application claims priority to Korean Patent Application No. 10-2024-0115083, filed on Aug. 27, 2024, in the Korean Intellectual Property Office, the disclosure of which is incorporated herein by reference.

### BACKGROUND OF THE DISCLOSURE

### Field of the Disclosure

The present disclosure relates to a conductive metal film and a method of fabricating the same. More particularly, the present disclosure relates to a conductive metal film obtained by fabricating a metal nanoparticle film in which the formation of an oxide film is suppressed and subsequently subjecting the film to light irradiation, and a method of fabricating the conductive metal film.

### Description of the Related Art

Copper nanoparticles are attracting considerable attention as a material that can be used in conductive inks, because they offer excellent cost competitiveness while providing high electrical conductivity. However, when a firing reaction is carried out through heat treatment in air which is essential for securing conductivity, copper nanoparticles undergo oxidation, unlike silver nanoparticles. Accordingly, the present disclosure provides an optimal material technology for preventing oxidation even when the firing reaction is performed.

### SUMMARY OF THE DISCLOSURE

Therefore, the present disclosure has been made in view of the above problems, and it is an object of the present disclosure to provide a conductive metal film in which an organic molecule containing carboxylic acid is adsorbed onto a metal film to suppress the formation of an oxide film and to reduce an oxide film even if it is formed.

It is another object of the present disclosure to provide a metal film in which the time required for an oxide film to be formed is shortened even when the metal film is fired in air, thereby maintaining electrical conductivity.

It is still another object of the present disclosure to provide a conductive metal film that may undergo photonic irradiation under a wide range of conditions during a firing reaction and that exhibits high conductivity after the photonic irradiation.

It is yet another object of the present disclosure to provide a conductive metal film which can exhibit electrical conductivity upon firing, even when the metal nanoparticles are stored in air for a long time.

In accordance with an aspect of the present disclosure, the above and other objects can be accomplished by the provision of a method of fabricating a conductive metal film, the method including: manufacturing a metal nanoparticle ink by mixing an organic molecule containing carboxylic acid having 1 to 17 carbon atoms in a solution in which metal nanoparticles are dispersed; forming a metal nanoparticle film by coating the metal nanoparticle ink on a substrate; and thermally treating the metal nanoparticle film.

According to an embodiment, the metal nanoparticles may be bound to a capping agent, and the metal nanoparticles may include at least one selected from the group consisting of copper, nickel, tin, iron, aluminum, molybdenum, tungsten, gallium, indium, and alloys thereof.

According to an embodiment, the capping agent may prevent the metal nanoparticles from contacting moisture or oxygen and serve to improve the dispersibility of the metal nanoparticles.

According to an embodiment, the capping agent may be a polymer or organic molecule including at least one selected from the group consisting of pyridine, phosphine, phosphine oxide, amine, thiol, and hydroxyl functional groups.

According to an embodiment, the organic molecule containing carboxylic acid may include 1 to 4 carboxyl groups, and may be one or more selected from the group consisting of fatty acids, hydroxycarboxylic acids, amino acids, and aromatic acids.

According to an embodiment, the organic molecule containing carboxylic acid may include formic acid, propionic acid, or butyric acid.

According to an embodiment, the thermally treating of the metal nanoparticle film may be one or more selected from the group consisting of furnace heat treatment, laser irradiation heat treatment, white light irradiation heat treatment, plasma heat treatment, microwave heat treatment, and Joule heating.

According to an embodiment, in the thermally treating of the metal nanoparticle film, the laser irradiation heat treatment, the white light irradiation heat treatment, the plasma heat treatment and the microwave heat treatment may be performed in air.

According to an embodiment, the laser may be irradiated at a power of 0.5 W to 20 W.

According to an embodiment, the laser may be irradiated at a scanning speed of 100 mm/sec to 2,000 mm/sec.

In accordance with another aspect of the present disclosure, provided is a conductive metal film, fabricated by the method according to the present disclosure, wherein the conductive metal film includes: metal nanoparticles; and an organic molecule containing a carboxylic acid having 1 to 17 carbon atoms, adsorbed on the metal nanoparticles, wherein the organic molecule containing carboxylic acid prevents formation of an oxide film on the metal nanoparticles and removes the oxide film even if the oxide film is formed.

According to an embodiment, the organic molecule containing carboxylic acid may be adsorbed on the surfaces of the metal nanoparticles.

According to an embodiment, when a conductive metal film is fabricated using the metal nanoparticles stored in air for 1 to 60 days, the conductive metal film may have an electrical conductivity of 1.10×10⁴ S/cm to 9.07×10⁴ S/cm.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1A illustrates the results of analyzing Preparation Example 1 by X-ray Photoelectron Spectroscopy (XPS);

FIG. 1B illustrates the calculated ratios of each composition based on the results of X-ray Photoelectron Spectroscopy (XPS) analysis of Preparation Example 1;

FIG. 2 illustrates the electrical conductivity of Comparative Example 1-2 depending on laser irradiation conditions;

FIGS. 3A and 3B illustrate the results of analyzing Comparative Example 1-2 by X-ray Photoelectron Spectroscopy (XPS);

FIG. 3C illustrates composition ratios calculated based on the results of X-ray Photoelectron Spectroscopy (XPS) analysis of Comparative Example 1-2;

FIG. 4 illustrates an SEM (Scanning Electron Microscope) image of Comparative Example 1-2;

FIG. 5 illustrates the electrical conductivity of Example 1-2 depending on laser irradiation conditions;

FIG. 6 illustrates a scanning electron microscope (SEM) image of Example 1-2;

FIG. 7 illustrates the electrical conductivity of Example 2-2 depending on laser irradiation conditions;

FIGS. 8A and 8B illustrate the results of analyzing Example 2-2 by X-ray Photoelectron Spectroscopy (XPS);

FIG. 8C illustrates composition ratios calculated based on the results of X-ray Photoelectron Spectroscopy (XPS) analysis of Example 2-2;

FIG. 9 illustrates a scanning electron microscope (SEM) image of Example 2-2;

FIG. 10 illustrates the electrical conductivity of Example 3-2 depending on laser irradiation conditions;

FIG. 11 illustrates a scanning electron microscope (SEM) image of Example 3-2;

FIG. 12 illustrates the electrical conductivity of Comparative Example 2-2 depending on laser irradiation conditions; and

FIG. 13 illustrates a scanning electron microscope (SEM) image of Comparative Example 2-2.

### DETAILED DESCRIPTION OF THE DISCLOSURE

The present disclosure will now be described more fully with reference to the accompanying drawings and contents disclosed in the drawings. However, the present disclosure should not be construed as limited to the exemplary embodiments described herein.

The terms used in the present specification are used to explain a specific exemplary embodiment and not to limit the present inventive concept. Thus, the expression of singularity in the present specification includes the expression of plurality unless clearly specified otherwise in context. It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

In addition, as used in the description of the disclosure and the appended claims, the singular forms “a”, “an” and “the” are intended to include the plural forms as well, unless context clearly indicates otherwise.

Further, when an element such as a layer, a film, a region, and a constituent is referred to as being “on” another element, the element can be directly on another element or an intervening element can be present.

A method of fabricating a conductive metal film according to the present disclosure includes: a step of manufacturing a metal nanoparticle ink by mixing an organic molecule containing carboxylic acid having 1 to 17 carbon atoms in a solution in which metal nanoparticles are dispersed; a step of forming a metal nanoparticle film by coating the metal nanoparticle ink on a substrate; and a step of thermally treating the metal nanoparticle film.

Before the step of manufacturing a metal nanoparticle ink in the method of fabricating a conductive metal film, a step of manufacturing metal nanoparticles may be further included. The manufactured metal nanoparticles may have a size of 10 nm to 200 nm and may be a mixture including metal micron particles having a size of 0.2 μm to 50 μm.

In the step of manufacturing metal nanoparticles, the metal nanoparticles may include at least one selected from the group consisting of copper, nickel, tin, iron, aluminum, molybdenum, tungsten, gallium, indium, and alloys thereof, and in the step of manufacturing metal nanoparticles, the metal nanoparticles may be bound to a capping agent.

The capping agent may serve to suppress the overgrowth of particles caused by collisions due to Brownian motion during high-temperature synthesis, and may also act as a surface protective layer of the metal nanoparticles to prevent direct contact with moisture and oxygen, thereby suppressing oxidation of the metal nanoparticles.

In addition, since the capping agent is bound to the metal nanoparticles, the dispersibility of the metal nanoparticles in a solvent may be improved.

The capping agent may be a polymer or organic molecule including a functional group capable of binding to a metal, and more specifically, at least one selected from the group consisting of pyridine, phosphine, phosphine oxide, amine, thiol, and hydroxyl functional groups.

Non-limiting examples of capping agents containing a pyridine functional group may include at least one selected from the group consisting of polyvinylpyrrolidone, poly(N-vinyl-2-pyrrolidone), and 4-(dimethyl amino)pyridine, and non-limiting examples of capping agents containing a phosphine functional group may include at least one selected from the group consisting of trioctylphosphine, triphenylphosphine, tri(p-tolyl)phosphine, 1,2-bis(diphenylphosphino)ethane, and 1,2-bis(diphenylphosphino)propane.

Non-limiting examples of capping agents containing a phosphine oxide functional group may include trioctylphosphine oxide or triphenylphosphine oxide, and non-limiting examples of capping agents containing an amine functional group may include at least one selected from the group consisting of oleylamine, hexylamine, dodecylamine, octadecylamine, and dimethylethanolamine.

Non-limiting examples of capping agents containing a thiol functional group may include at least one selected from the group consisting of 1-octanethiol, 1-dodecanethiol, 1,9-nonanedithiol, 4-toluenethiol, benzene-1,4-dithiol, poly(ethylene glycol) methyl ether thiol, and 5-methyl-1,3,4-thiadiazole-2-thiol, and non-limiting examples of capping agents containing a hydroxyl functional group may include polyethylene glycol or polypropylene glycol.

In the step of manufacturing a metal nanoparticle ink, an organic molecule containing carboxylic acid may be added to a polar solvent in which metal nanoparticles are dispersed, followed by stirring.

In the step of manufacturing the metal nanoparticle ink, the polar solvent may be selected from the group consisting of acetone, methyl ethyl ketone, methanol, ethanol, isopropanol, butanol, ethylene glycol, polyethylene glycol, tetrahydrofuran, dimethylformamide, dimethylacetamide, and N-methyl-2-pyrrolidone. The organic molecule containing carboxylic acid may be adsorbed onto the surface of the metal nanoparticles to suppress an oxidation reaction of the metal nanoparticles and to reduce a surface oxide film.

The number of carbon atoms in the organic molecule containing carboxylic acid may be from 1 to 17.

When the number of carbon atoms of the organic molecule containing carboxylic acid exceeds 17, the adsorption reaction between the organic molecule and the metal nanoparticles may be limited due to steric hindrance with a capping agent bound to the surface of the metal nanoparticles. That is, the organic molecule containing carboxylic acid having more than 17 carbon atoms is blocked by the capping agent and thus has difficulty approaching the surface of the metal nanoparticles. When such an organic molecule having more than 17 carbon atoms is used, the functional carboxylic acid group thereof is adsorbed onto the reactive group of the capping agent, and during heat treatment, the organic molecule undergoes carbonization, thereby failing to function in suppressing the formation of the oxide film. Therefore, when a metal nanoparticle film is fabricated using an organic molecule containing carboxylic acid having more than 17 carbon atoms, the suppression of oxide film formation and the initiation of reduction reaction cannot be achieved during heat treatment, and the film cannot function as a conductive film.

The organic molecule containing carboxylic acid may be selected from the group consisting of a fatty acid, a hydroxycarboxylic acid, an amino acid, and an aromatic acid, each including one carboxyl group, or may be an organic molecule including two to four carboxyl groups. Preferably, the organic molecule containing carboxylic acid may be formic acid, propionic acid, or butyric acid.

Non-limiting examples of fatty acids including one carboxyl group may include at least one selected from the group consisting of formic acid, acetic acid, propionic acid, butyric acid, valeric acid, caproic acid, caprylic acid, decanoic acid, and lauric acid, and non-limiting examples of hydroxycarboxylic acids including one carboxyl group may include glycolic acid or lactic acid.

Non-limiting examples of amino acids including one carboxyl group may include at least one selected from the group consisting of glycine, alanine, serine, and threonine, and non-limiting examples of aromatic acids including one carboxyl group may include 2-furoic acid or niacin.

Non-limiting examples of organic molecules including two to four carboxyl groups may include at least one selected from the group consisting of oxalic acid, maleic acid, malonic acid, fumaric acid, malic acid, ascorbic acid, succinic acid, adipic acid, glutaric acid, tartaric acid, citric acid, aconitic acid, propane-1,2,3-tricarboxylic acid, trimesic acid, and ethylenediamine-tetraacetic acid.

An organic molecule containing carboxylic acid may be selected from the group consisting of monomers having a functional carboxylic acid group with 1 to 17 carbon atoms.

In one embodiment, the organic molecule containing carboxylic acid may be selected from the group consisting of monomers having a carboxylic acid functional group with 1 to 3 carbon atoms. Non-limiting examples thereof may include at least one selected from the group consisting of formic acid, acetic acid, propionic acid, glycolic acid, lactic acid, glycine, alanine, serine, threonine, 2-furoic acid, niacin, oxalic acid, and malonic acid.

In an embodiment, the organic molecule containing carboxylic acid may be selected from the group consisting of monomers having a carboxylic acid functional group with 4 to 17 carbon atoms. Non-limiting examples thereof may include at least one selected from the group consisting of butyric acid, valeric acid, caproic acid, caprylic acid, decanoic acid, lauric acid, maleic acid, fumaric acid, malic acid, ascorbic acid, succinic acid, adipic acid, glutaric acid, tartaric acid, citric acid, aconitic acid, propane-1,2,3-tricarboxylic acid, trimesic acid, and ethylenediamine-tetraacetic acid.

The organic molecule containing carboxylic acid may be used in an amount of 1% by mass to 15% by mass based on the total weight of the metal nanoparticles.

When the organic molecule containing carboxylic acid is used in an amount of less than 1 wt %, it cannot function to suppress the formation of the oxide film or to reduce the oxide film. When used in an amount exceeding 15 wt %, excessive adsorption of the organic molecule may occur, which can cause deterioration of conductivity.

In the step of manufacturing a metal nanoparticle film, the metal nanoparticle ink may be applied on an upper surface of a glass substrate or a polymer substrate and dried at room temperature, and may be coated by one method selected from spin coating, bar coating, slot-die coating, tape casting, inkjet printing, dispensing printing, and screen printing.

The thickness of the manufactured metal nanoparticle film may be 0.1 μm to 30 μm.

When the film thickness is less than 0.1 μm, the three-dimensional connectivity of the metal nanoparticles is not secured, and conductivity cannot be exhibited. When the film thickness exceeds 30 μm, cracks may occur due to shrinkage after firing, and delamination from the substrate may occur.

So as for the metal nanoparticle film to exhibit electrical conductivity, a firing process should be accompanied. Therefore, after the step of manufacturing the metal nanoparticle film, a heat treatment step may be performed to induce electrical conductivity.

In the heat treatment step, the heat treatment may be carried out by any one method selected from furnace heat treatment, Joule heating, laser irradiation heat treatment, white light irradiation heat treatment, plasma heat treatment, and microwave heat treatment, and may be performed under an inert gas atmosphere or in air.

Here, furnace heat treatment means heat treatment performed in a furnace. Joule heating is a method of heating a metal object using electromagnetic induction, in which eddy currents are generated in the metal to be heated when a current is supplied to a coil, and the Joule heat generated by the resistance of the metal increases the temperature.

The heat treatment step may be carried out under an inert gas atmosphere or in air.

More specifically, when heat treatment is performed at high temperature, the process may be carried out under an inert gas atmosphere such as argon (Ar) or nitrogen (N₂).

When the firing process is performed by furnace heat treatment, there is an advantage of obtaining high conductivity, but it requires a relatively long time. So, the metal nanoparticles may be oxidized during the heat treatment period, thereby losing the properties of the metal material. Therefore, an inert gas atmosphere must be maintained during the heat treatment.

However, when furnace heat treatment is carried out, manufacturing costs may increase due to the need to control the inert gas atmosphere and the prolonged heat treatment time, and selective firing of electrode patterns is impossible, so it may be limited in terms of integration processes due to substrate and chip damage.

In the heat treatment step, when photonic irradiation, such as laser irradiation heat treatment or white light irradiation heat treatment, is performed, the process may be carried out in air. Here, “in air” means that oxygen is 21 v/v % and the pressure is 1 atm.

When photonic irradiation is performed, light energy is converted into thermal energy, producing an effect similar to that of heat treatment. Even when photonic irradiation is carried out for a short time of about 1 msec, an effect similar to that of heat treatment may be obtained, so the process can be performed without concern about oxidation of the metal in air. In addition, since only the electrode pattern can be fired, the process may be carried out without degradation of the properties of passive or active chips mounted on the substrate.

In the heat treatment step, the photonic irradiation may be laser irradiation.

Metal nanoparticles have plasmonic light absorption characteristics at specific wavelengths. Therefore, in the photonic irradiation step, when white light in which all visible light wavelengths are irradiated is used, most of the wavelengths cannot be absorbed, resulting in poor irradiation efficiency and inevitable substrate damage. In contrast, in the case of short-wavelength laser photonic irradiation that matches the light-absorption wavelength of the metal nanoparticles, the efficiency of photonic irradiation may be maximized through light absorption control while minimizing substrate damage.

In one embodiment, the process window of photonic irradiation may be extended by adsorbing the organic molecule containing carboxylic acid onto the metal nanoparticles.

Generally, when photonic irradiation is carried out at high power or at a slow scanning speed, a large amount of light energy per unit time reaches the metal nanoparticle film, thereby causing an oxidation reaction in the irradiated region and leading to the formation of an oxide film.

According to one embodiment of the present disclosure, the organic molecule containing carboxylic acid adsorbed on the metal nanoparticles induces a reduction reaction of the oxide film formed by excessive light energy, thereby enabling the removal of the oxide film. The reduction and removal reactions of the oxide film caused by the organic molecule containing carboxylic acid are as follows.

The organic molecule containing carboxylic acid adsorbed on the surface of the metal nanoparticles by photonic irradiation may be separated into hydrogen ions and carboxylates. The separated hydrogen ions may bind to oxygen atoms present in the oxide film generated by photonic irradiation to be converted into hydroxyl groups, while the separated carboxylates may remain adsorbed on the surface of the oxide film.

Subsequently, the carboxylates are decomposed into carbon dioxide and alkyl radicals, and the highly reactive alkyl radicals combine with the hydroxyl groups converted from the hydrogen ions to volatilize as an alcohol gaseous by-product, whereby the oxide film may be removed.

That is, the organic molecule containing carboxylic acid included in the metal nanoparticle film enables reduction of the additional oxide film formed when high power is used for photonic irradiation or when the scanning speed of the light source is decreased, thereby allowing high conductivity to be secured even under high light energy conditions.

Generally, when photonic irradiation is carried out at low power or at a fast scanning speed, the amount of light energy delivered to the metal nanoparticle film per unit time is insufficient, and thus, a sufficient firing reaction may not occur, making it difficult for electrical conductivity to be exhibited.

According to one embodiment of the present disclosure, even when the amount of light energy delivered to the metal nanoparticle film per unit time is insufficient for a sufficient firing reaction to proceed, additional firing reactions may occur due to the reduction and removal reactions of the oxide film caused by the organic molecule containing carboxylic acid, thereby enabling sufficient manifestation of electrical conductivity.

In the photonic irradiation step, the laser may be irradiated at a power of 0.5 W to 20 W. Preferably, the laser may be irradiated at a power of 1.5 W to 4 W.

In the photonic irradiation step, the scanning speed of the laser may be 100 mm/sec to 2,000 mm/sec, and more preferably 500 mm/sec to 1,200 mm/sec. The scanning speed of the laser may refer to the speed at which the laser irradiation part moves across the metal nanoparticle film during laser irradiation.

The organic molecule containing carboxylic acid may be adsorbed onto the oxide film formed on the surface of the metal nanoparticles. The oxide film formed on the surface of the metal particles has hydroxyl groups, and the organic molecule containing carboxylic acid has highly polar functional groups. Therefore, surface adsorption of the organic molecule containing carboxylic acid can occur through physical bonding (Keesom Force) acting at the highly polar functional groups.

The electrical conductivity of a conductive metal film fabricated using the manufactured metal nanoparticles stored in air for 1 to 60 days according to the method of the present disclosure may be 1.10×10⁴ S/cm to 9.07×10⁴ S/cm.

More specifically, the electrical conductivity of a conductive metal film fabricated by photonic sintering after storing the metal nanoparticles in air for 1 to 60 days may be 1.10×10⁴ S/cm to 1.42×10⁴ S/cm, and the electrical conductivity of a conductive film fabricated by performing heat treatment after storage may be 4.32×10⁴ S/cm to 9.07×10⁴ S/cm.

The above-described conductivity values may correspond to 85% to 94% of the electrical conductivity of a conductive metal film manufactured using metal nanoparticles that have not been stored and subjected to photonic irradiation or furnace heat treatment.

In the case of copper nanoparticles stored in air for a long time, the surface oxide film may significantly increase, and when such long-stored metal nanoparticles are used to fabricate a conductive metal film, electrical conductivity may drastically decrease. However, in the present disclosure, a reduction reaction of the oxide film generated during the heat treatment step can occur due to the presence of an organic molecule containing carboxylic acid, thereby ensuring long-term stability of the material.

That is, even when the manufactured metal nanoparticles according to the method of the present disclosure are stored in air for a long time, the oxide film increased during storage can be removed through the reduction reaction of the oxide film caused by the organic molecule containing carboxylic acid during the heat treatment step, and high electrical conductivity can be maintained, thereby ensuring long-term stability of the material.

Hereinafter, the present disclosure will be described in further detail with reference to examples and drawings. These examples are provided to more specifically illustrate the present disclosure, and the scope of the present disclosure is not limited to the examples.

### [Preparation Example 1] Copper Nanoparticles

56 g of polyvinylpyrrolidone (PVP) having a molecular weight of 58,000 was added to 280 ml of diethylene glycol, followed by stirring at 90° C. for 30 minutes to dissolve the solution. The stirred solution was cooled to room temperature, and 2.35 g of sodium phosphinate monohydrate (NaH₂PO₂·H₂O) was added, after which the solution was stirred and heated to 130° C. Separately, 7 g of copper sulfate pentahydrate (CuSO₄·5H₂O) was dissolved in 21 ml of distilled water and introduced at an injection rate of 1 ml/min, followed by stirring for 1 hour to be reacted. The resulting reaction solution was cooled to room temperature, and centrifuged at 7000 rpm for 15 minutes to obtain a precipitate. The obtained precipitate was purified twice by centrifugation with ethanol. As a result, copper nanoparticles without an oxide film (Preparation Example 1) were produced.

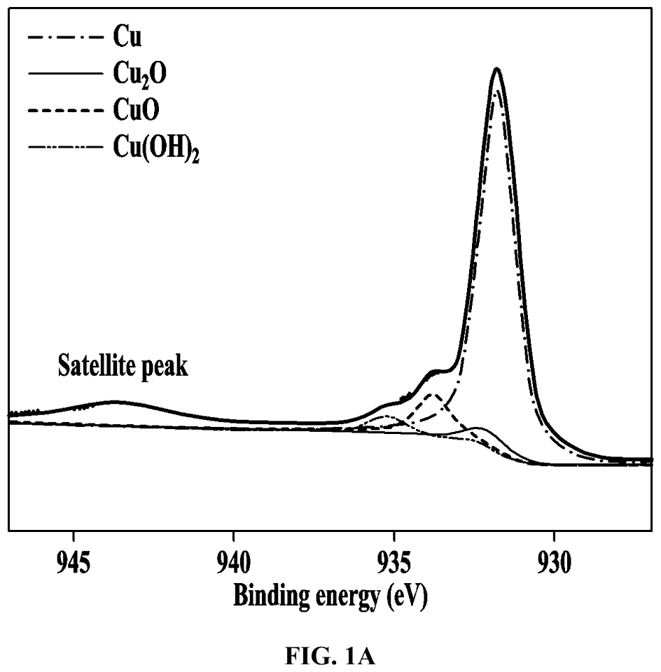

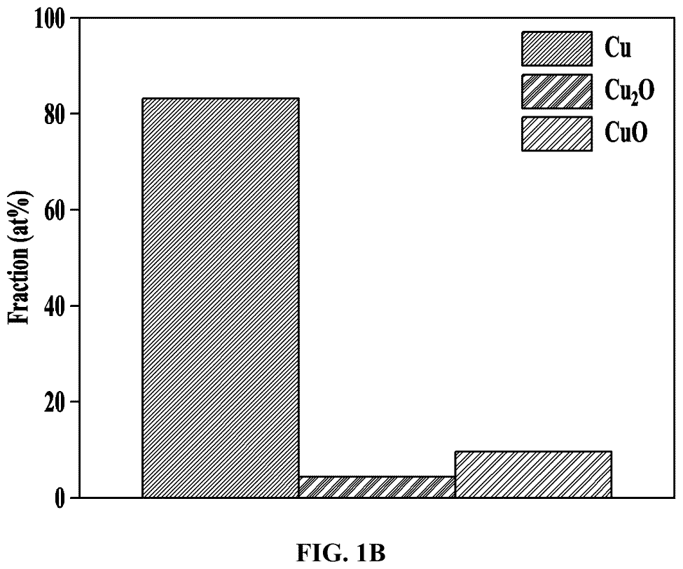

FIG. 1A illustrates the results of analyzing Preparation Example 1 by X-ray Photoelectron Spectroscopy (XPS). Referring to FIG. 1A, it can be seen that copper particles (Cu) with little oxide film formation were synthesized in Preparation Example 1.

FIG. 1B illustrates the calculated ratios of each composition based on the results of X-ray Photoelectron Spectroscopy (XPS) analysis of Preparation Example 1. Referring to FIG. 1B, the proportion of copper oxides (CuO, Cu²O) was 13.6 at %, confirming that most of the copper remained unoxidized.

### [Comparative Example 1-1] Fabrication of Copper Nanoparticle Film

Copper nanoparticles without an oxide film, prepared in Preparation Example 1, were dispersed in ethanol solvent at a concentration of 20 wt % to prepare a coating ink. A Kapton HN film with a thickness of 75 μm was subjected to UV ozone cleaning for 30 minutes, and then the copper nanoparticle ink was bar-coated twice at a thickness of 70 μm per coating and dried at room temperature to prepare Comparative Example 1-1.

### [Comparative Example 1-2] Laser-Irradiated Copper Nanoparticle Film

The copper nanoparticle film of Comparative Example 1-1 was irradiated with a green laser having a wavelength of 532 nm at various scanning speeds and power levels to fabricate a 1 mm×0.1 mm sample of Comparative Example 1-2.

### [Comparative Example 1-3] Copper Nanoparticle Film

Except that a slide glass was used instead of a Kapton HN film with a thickness of 75 μm, copper nanoparticles were coated in a size of 20 mm×20 mm and dried at room temperature by the same method as in Comparative Example 1-1 to prepare Comparative Example 1-3.

### [Comparative Example 1-4] Heat-Treated Copper Nanoparticle Film

The copper nanoparticle film of Comparative Example 1-3 was subjected to furnace heat treatment under an argon (Ar) atmosphere. The heat treatment was performed for 1 hour at temperatures of 350° C., 400° C., and 450° C., respectively.

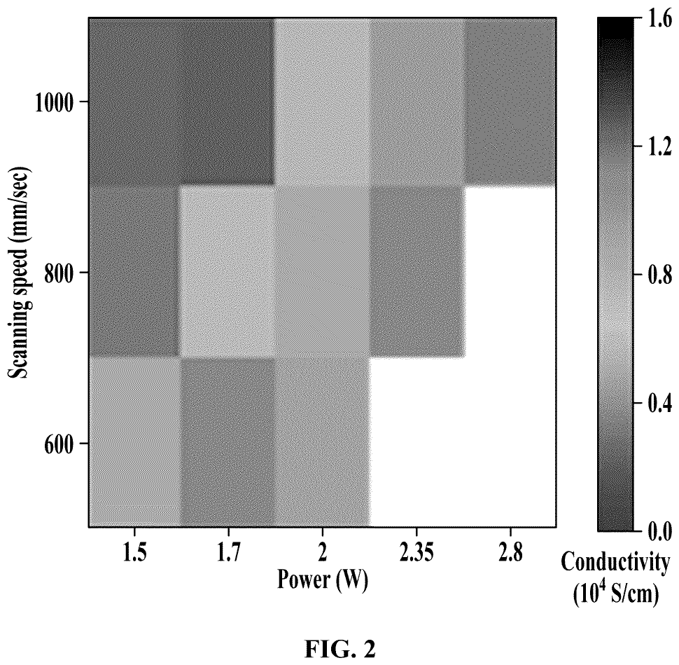

FIG. 2 illustrates the electrical conductivity of Comparative Example 1-2 depending on laser irradiation conditions. Referring to FIG. 2, conductivity of 10⁴ S/cm or higher could be exhibited only when the laser was irradiated at a low power of 1.75 W or less and a high scanning speed of 800 mm/sec or more (low delivered light energy). In contrast, when the laser was irradiated at higher power and slower scanning speed (high delivered light energy), additional oxide film formation occurred, limiting the conductivity to 10⁴ S/cm or less.

For example, an electrical conductivity of 0.45×10⁴ S/cm was measured after a laser process at a power of 2.35 W and a scanning speed of 1000 mm/sec, and an electrical conductivity of 0.37×10⁴ S/cm was measured after a laser process at a power of 1.7 W and a scanning speed of 600 mm/sec.

As such, copper nanoparticles without surface treatment (i.e., without adsorption of the organic molecule containing carboxylic acid, hereinafter referred to as “surface treatment”) exhibited electrical conductivity of 10⁴ S/cm or higher only in a very narrow range of power and scanning speed conditions (low delivered light energy). Under conditions of high delivered light energy, the nanoparticles were oxidized during laser irradiation and thus failed to exhibit high electrical conductivity.

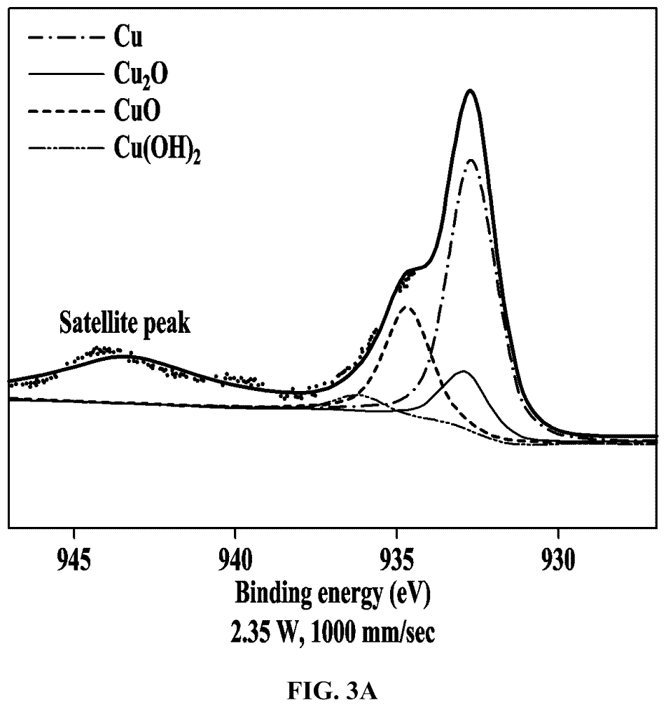

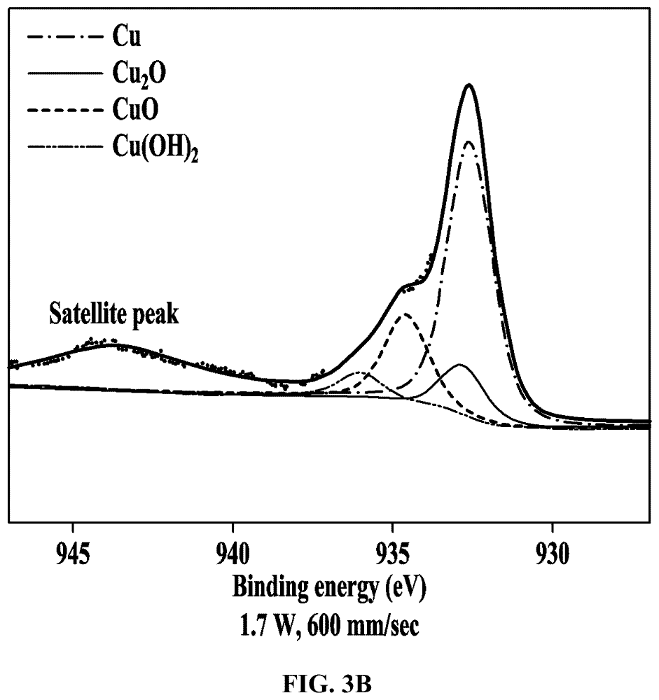

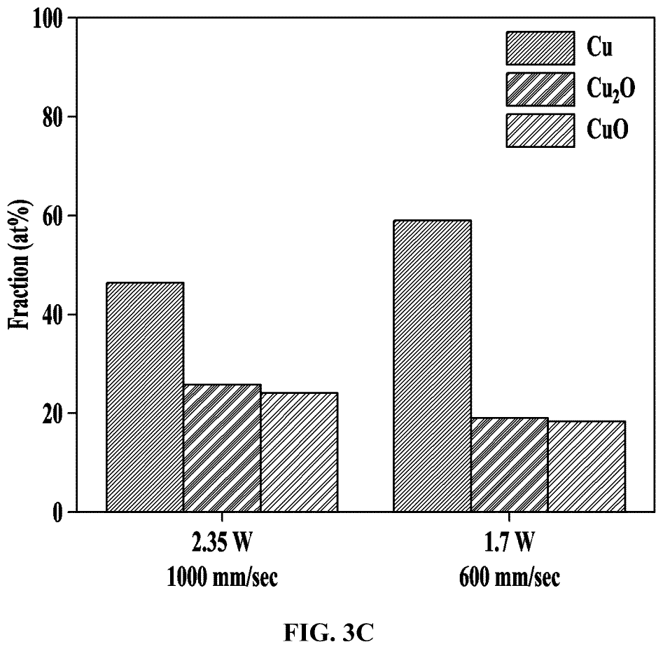

FIGS. 3A and 3B illustrate the results of analyzing Comparative Example 1-2 by X-ray Photoelectron Spectroscopy (XPS).

Referring to FIG. 3A, it can be seen that the copper nanoparticles were oxidized when irradiated with a laser under high-power conditions (2.35 W, 1000 mm/sec). In addition, referring to FIG. 3B, it can be seen that the copper nanoparticles were oxidized after laser-firing under low scanning speed conditions (1.7 W, 600 mm/sec).

FIG. 3C illustrates composition ratios calculated based on the results of X-ray Photoelectron Spectroscopy (XPS) analysis of Comparative Example 1-2.

Referring to FIG. 3C, after laser firing under high-power conditions (2.35 W, 1000 mm/sec), the proportion of copper oxides (CuO, Cu²O) was 50.1 at %, and after laser firing under low scanning speed conditions (1.7 W, 600 mm/sec), the proportion of copper oxides (CuO, Cu²⁰) was 37.1 at %. This confirms that a large amount of oxide film was formed under both conditions.

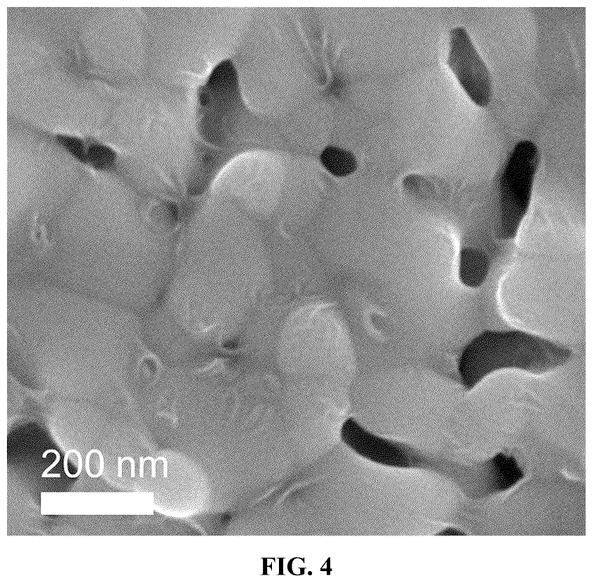

FIG. 4 illustrates an SEM (Scanning Electron Microscope) image of Comparative Example 1-2 (laser conditions: 1.7 W, 600 mm/sec). Referring to FIG. 4, Comparative Example 1-2 included copper nanoparticles that were not surface-treated with an organic molecule containing carboxylic acid, and due to the oxide film formed during laser irradiation, a sufficient firing reaction did not occur, resulting in a relatively low density.

### [Example 1-1] Copper Nanoparticle Film Surface-Functionalized with Formic Acid

Copper nanoparticles prepared in Preparation Example 1 were dispersed in an ethanol solvent at a concentration of 20 wt %, and formic acid (FA) corresponding to 3 wt % of the nanoparticles was added and stirred for 30 minutes to prepare a copper nanoparticle ink where formic acid was adsorbed. Example 1-1 was then fabricated by the same process as Comparative Example 1-1.

### [Example 1-2] Laser Irradiation to Copper Nanoparticle Film Surface-Functionalized With Formic Acid

In Example 1-1, lasers of various power levels and scanning speeds were irradiated to form light-irradiated patterns with a size of 1 mm×0.1 mm.

### [Example 1-3] General Heat Treatment of Copper Nanoparticle Film Surface-Functionalized with Formic Acid

Except that slide glass was used instead of a Kapton HN film having a thickness of 75 μm, copper nanoparticles were coated in a size of 20 mm×20 mm and dried at room temperature in the same manner as Example 1-1 to prepare Example 1-3.

### [Example 1-4] General Heat Treatment of Copper Nanoparticle Film Surface-Functionalized with Formic Acid

The film of Example 1-3 was subjected to furnace heat treatment under an argon atmosphere. The heat treatment was carried out at 350° C., 400° C., and 450° C. for 1 hour each.

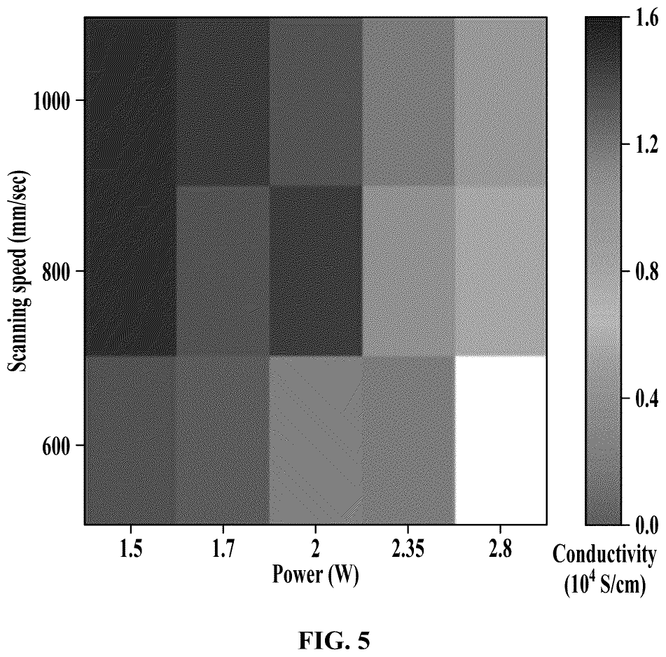

FIG. 5 illustrates the electrical conductivity of Example 1-2 depending on laser irradiation conditions. Referring to FIG. 5, conductivity of 10⁴ S/cm or higher could be exhibited when the laser was irradiated at a low power of 2.35 W or less and a high scanning speed of 600 mm/sec or more. When the laser was irradiated at a higher power and a slower scanning speed, removal of the additionally formed oxide film was possible, and when the laser was irradiated at a lower power and a higher scanning speed, high conductivity was still exhibited. For example, an electrical conductivity of 1.17×10⁴ S/cm was measured after a laser process at 2.35 W and 1000 mm/sec, and an electrical conductivity of 1.29×10⁴ S/cm was measured after a laser process at 1.7 W and 600 mm/sec.

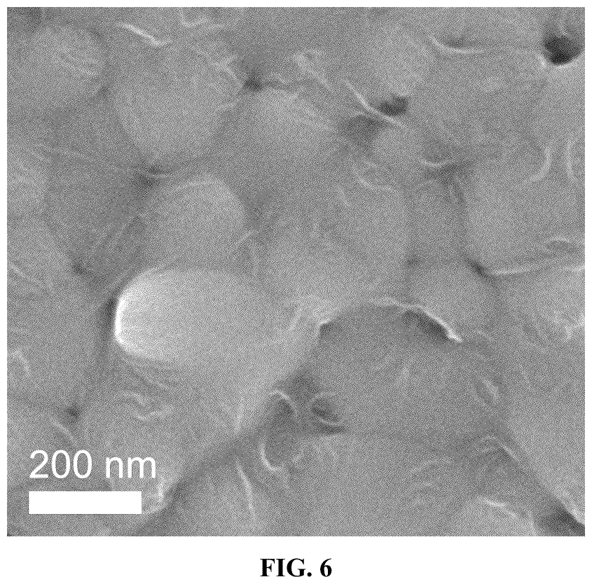

FIG. 6 illustrates a scanning electron microscope (SEM) image of Example 1-2 (laser conditions: 1.7 W, 600 mm/sec). Referring to FIG. 6, it was confirmed that the photonic irradiation reaction was sufficiently completed through the removal of the oxide film, resulting in the formation of a microstructure with very high density.

### [Example 2-1] Copper Nanoparticle Film Surface-Functionalized with Propionic Acid

The copper nanoparticles of Preparation Example 1 were dispersed in an ethanol solvent at a concentration of 20 wt %, and propionic acid (PA) corresponding to 3 wt % of the nanoparticles was added and stirred for 30 minutes to prepare functional copper nanoparticle ink where propionic acid was adsorbed. Example 2-1 was then fabricated by the same process as Comparative Example 1-1.

### [Example 2-2] Laser Irradiation to Copper Nanoparticle Film Surface-Functionalized with Propionic Acid

In Example 2-1, lasers of various power levels and scanning speeds were irradiated to form light-irradiated patterns with a size of 1 mm×0.1 mm.

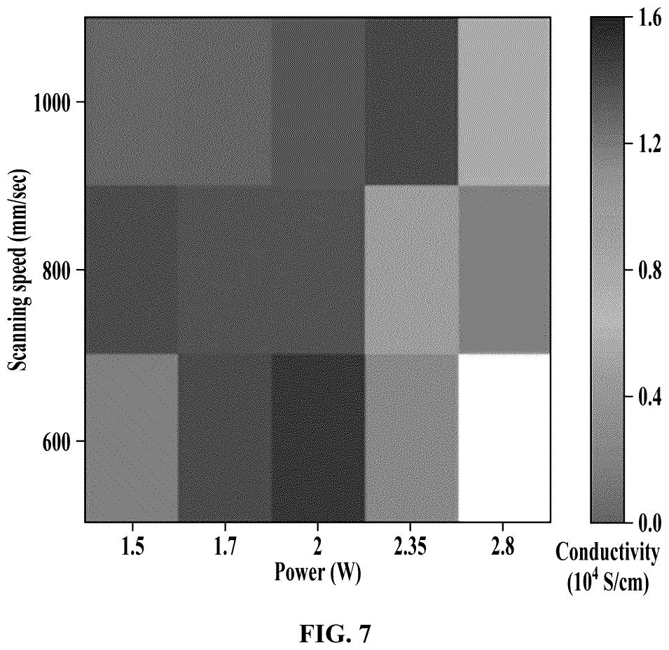

FIG. 7 illustrates the electrical conductivity of Example 2-2 depending on laser irradiation conditions. Referring to FIG. 7, a conductivity of 10⁴ S/cm or higher could be exhibited when the laser was irradiated at a low power of 2.35 W or less and a high scanning speed of 600 mm/sec or more. When the laser was irradiated at a higher power and a slower scanning speed, removal of additionally formed oxide films was possible, and when the laser was irradiated at a lower power and a higher scanning speed, high conductivity was also exhibited. For example, an electrical conductivity of 1.42×10⁴ S/cm was measured after a laser process at 2.35 W and 1000 mm/sec, at which additional oxide film formation could occur, and an electrical conductivity of 1.40×10⁴ S/cm was measured after a laser process at 1.7 W and 600 mm/sec.

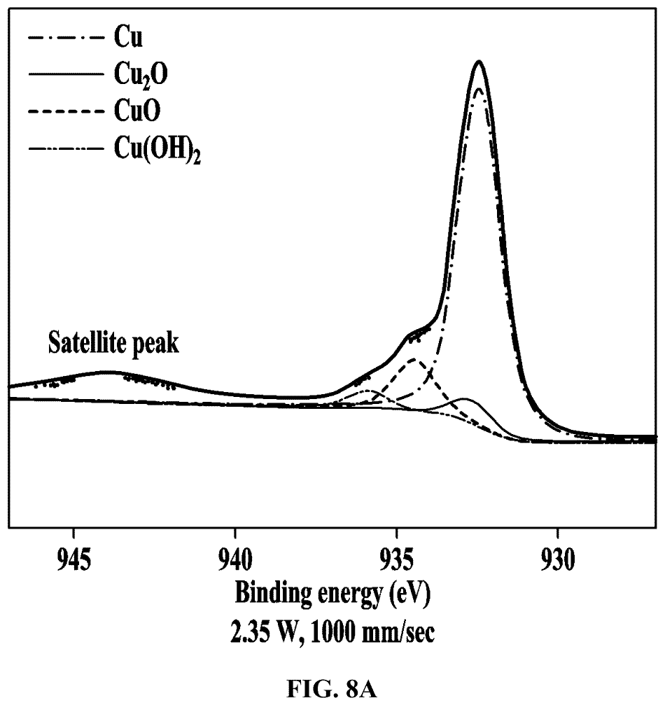

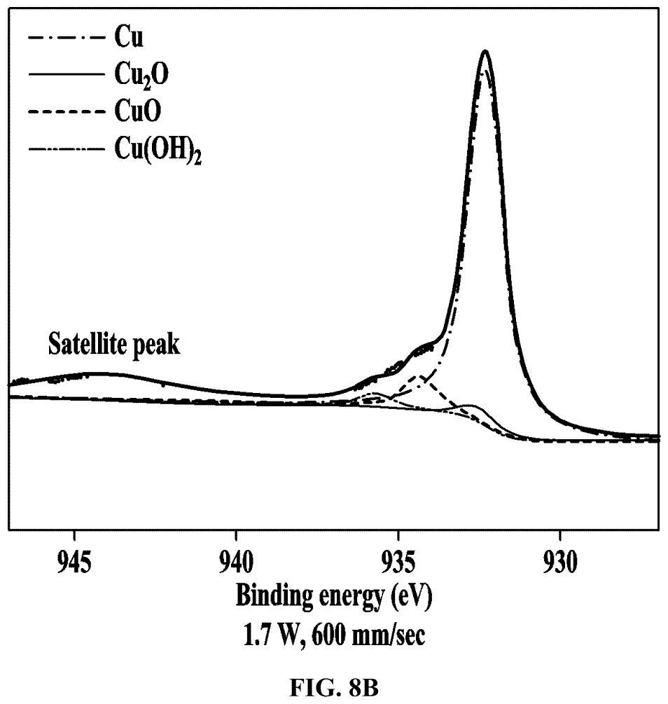

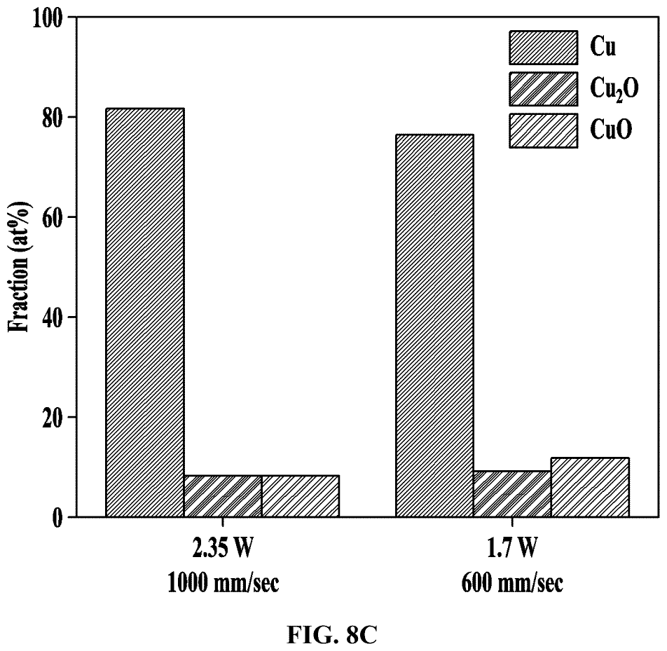

FIGS. 8A and 8B illustrate the results of analyzing Example 2-2 by X-ray Photoelectron Spectroscopy (XPS).

Referring to FIG. 8A, it was confirmed that almost no oxide film was generated on the copper nanoparticles after laser firing under high-power conditions (2.35 W, 1000 mm/sec). Referring to FIG. 8B, it was also confirmed that almost no oxide film was present on the copper nanoparticles even after laser firing under low scanning speed conditions (1.7 W, 600 mm/sec).

FIG. 8C illustrates composition ratios calculated based on the results of X-ray Photoelectron Spectroscopy (XPS) analysis of Example 2-2.

Referring to FIG. 8C, after laser firing under high-power conditions (2.35 W, 1000 mm/sec), the proportion of copper oxides (CuO, Cu₂O) was 16.2 at %, and after laser firing under low scanning speed conditions (1.7 W, 600 mm/sec), the proportion of copper oxides (CuO, Cu₂O) was 21.2 at %.

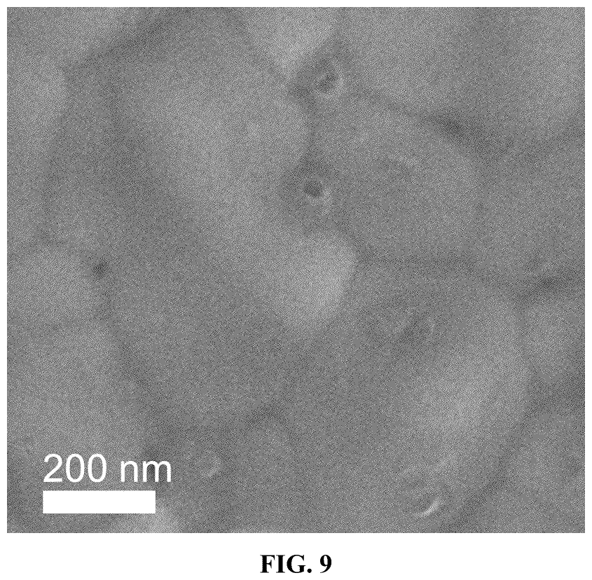

FIG. 9 illustrates a scanning electron microscope (SEM) image of Example 2-2 (laser conditions: 1.7 W, 600 mm/sec). Referring to FIG. 9, it was confirmed that a microstructure with very high density was formed after photonic sintering under the conditions of 1.7 W and 600 mm/sec. This indicates that the oxide film was efficiently removed by propionic acid, allowing a sufficient firing reaction to occur and thereby significantly improving the density.

### [Example 3-1] Copper Nanoparticle Film Surface-Functionalized with Butyric Acid

The copper nanoparticles of Preparation Example 1 were dispersed in an ethanol solvent at a concentration of 20 wt %, and butyric acid (BA) corresponding to 3 wt % of the nanoparticles was added and stirred for 30 minutes to prepare a functional copper nanoparticle ink where butyric acid was adsorbed. A film was then fabricated by the same process as Comparative Example 1-1.

### [Example 3-2] Laser Irradiation to Copper Nanoparticle Film Surface-Functionalized with Butyric Acid

Lasers of various power levels and scanning speeds were irradiated to Example 3-1 to fabricate light-irradiated patterns with a size of 1 mm×0.1 mm.

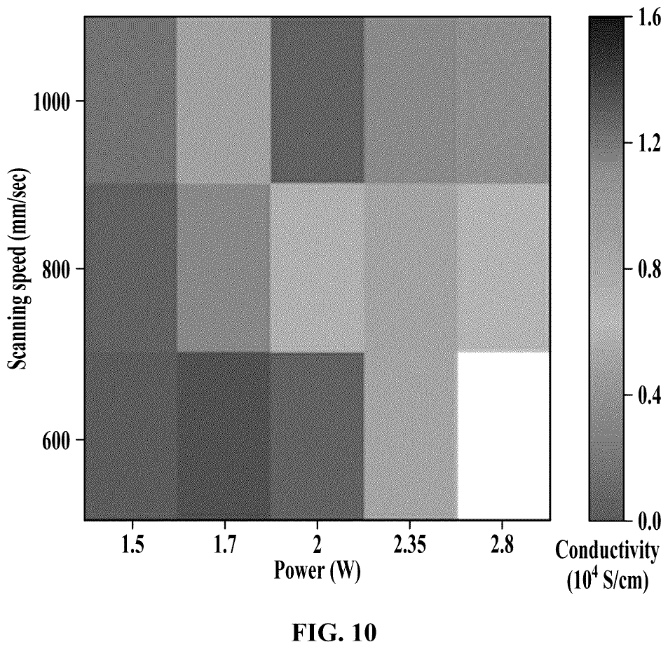

FIG. 10 illustrates the electrical conductivity of Example 3-2 depending on laser irradiation conditions. Referring to FIG. 10, a conductivity of 10⁴ S/cm or higher could be exhibited when the laser was irradiated at a low power of 1.7 W or less and a high scanning speed of 600 mm/sec or more. When the laser was irradiated at a higher power and a slower scanning speed, removal of additionally formed oxide films was only partially possible, while high conductivity could still be exhibited when the laser was irradiated at a lower power and a higher scanning speed. For example, an electrical conductivity of 1.13×10⁴ S/cm was measured after a laser process at a power of 2.35 W and an scanning speed of 1000 mm/sec where an additional oxide film can be formed, and an electrical conductivity of 1.36×10⁴ S/cm was measured after a laser process at a power of 1.7 W and a scanning speed of 600 mm/sec.

That is, copper nanoparticles surface-treated with butyric acid also exhibited electrical conductivity under a wide range of laser irradiation conditions, indicating that oxide films were removed. However, copper nanoparticles surface-treated with formic acid or propionic acid exhibited higher electrical conductivity under a wider range of irradiation conditions, confirming that they are more effective in suppressing oxide film formation.

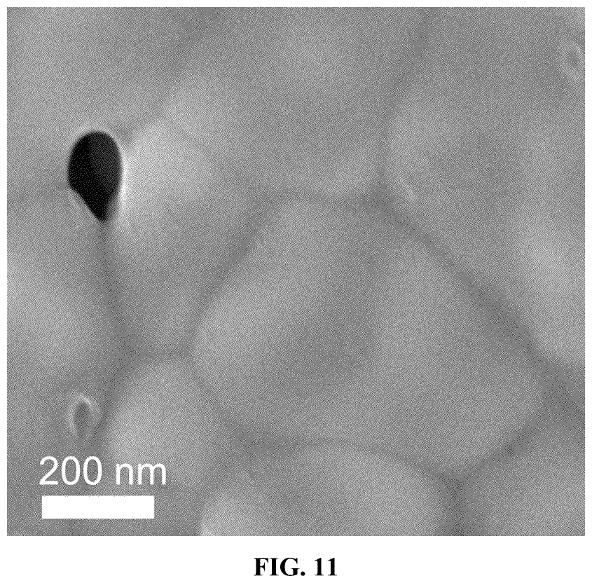

FIG. 11 illustrates a scanning electron microscope (SEM) image of Example 3-2 (laser conditions: 1.7 W, 600 mm/sec). Referring to FIG. 11, it was confirmed that a microstructure with high density was formed after photonic sintering.

### [Comparative Example 2-1] Copper Nanoparticle Film Surface-Functionalized with Oleic Acid

The copper nanoparticles of Preparation Example 1 were dispersed in an ethanol solvent at a concentration of 20 wt %, and oleic acid (OA) corresponding to 3 wt % of the nanoparticles was added and stirred for 30 minutes to prepare a copper nanoparticle ink where oleic acid was adsorbed. A film was then fabricated by the same process as Comparative Example 1-1.

### [Comparative Example 2-2] Laser Irradiation to Copper Nanoparticle Film Surface-Functionalized with Oleic Acid

Lasers of various power levels and scanning speeds were irradiated to Comparative Example 2-1 to fabricate light-irradiated patterns with a size of 1 mm×0.1 mm.

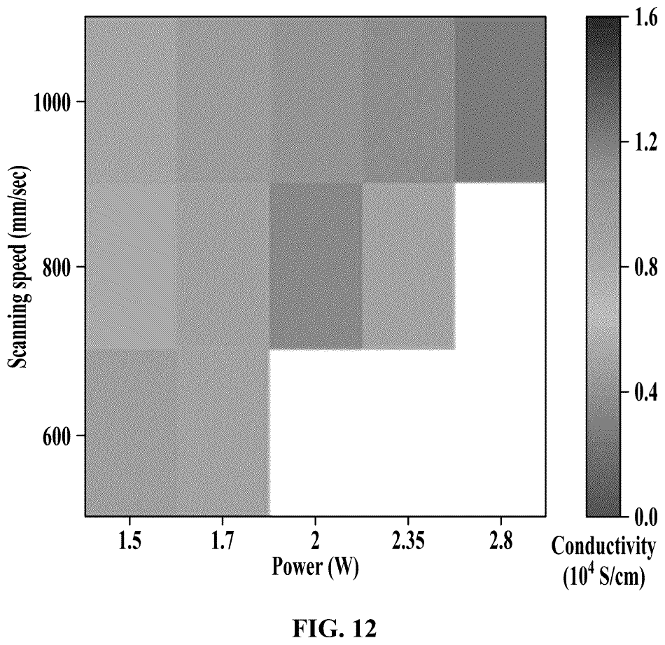

FIG. 12 illustrates the electrical conductivity of Comparative Example 2-2 depending on laser irradiation conditions. Referring to FIG. 12, Comparative Example 2-2 exhibited a low conductivity of 0.6×10⁴ S/cm or less under all laser conditions. This is because the bulky oleic acid could not be adsorbed on the surface of the copper nanoparticles due to steric hindrance with polyvinylpyrrolidone (PVP) present on the nanoparticle surface. As a result, the oleic acid remained adsorbed to the functional groups of the PVP and was carbonized, thereby failing to act as a functional group capable of reducing the oxide film.

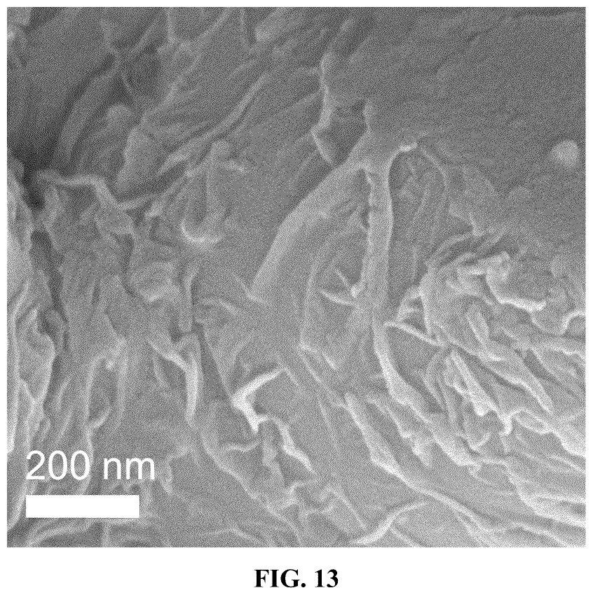

FIG. 13 illustrates a scanning electron microscope (SEM) image of Comparative Example 2-2 (laser conditions: 1.7 W, 600 mm/sec). Referring to FIG. 13, the uneven regions on the surface of the copper nanoparticle film were identified as carbonized oleic acid adsorbed on the PVP.

### [Property Evaluation] Comparison of Conductivity Between Heat-Treated and Laser-Treated Copper Nanoparticle Films

The copper nanoparticle films of Comparative Example 1 and Example 1 were fired by laser heat treatment in air or by furnace heat treatment under an argon (Ar) atmosphere, and their electrical conductivity was then measured.

TABLE 1

| Heat treatment | | | Conductivity |
|---|---|---|---|
| condition | Atmosphere | Sample | (10⁴ S/cm) |
| 1.7 W, 600 mm/sec | Air | Comparative | 0.37 |
| | | Example 1-2 | |
| 2.35 W, 1000 mm/sec | Air | Comparative | 0.45 |
| | | Example 1-2 | |
| 350° C. | Inert gas (Ar) | Comparative | — |
| | | Example 1-4 | |
| 400° C. | Inert gas (Ar) | Comparative | 1.45 |
| | | Example 1-4 | |
| 450° C. | Inert gas (Ar) | Comparative | 4.28 |
| | | Example 1-4 | |

Referring to Table 1, when a film fabricated using copper nanoparticles not surface-treated with the organic molecule containing carboxylic acid was subjected to laser heat treatment in air, a low conductivity of less than 0.45×10⁴ S/cm was measured under high-power conditions (2.35 W, 1000 mm/sec) and low scanning speed conditions (1.7 W, 600 mm/sec), in which an additional oxide film was formed. This indicates that photonic irradiation was limited due to the additional oxide films generated during the laser firing process.

In addition, when furnace heat treatment was carried out for 1 hour under an argon (Ar) atmosphere, electrical conductivity was not measured at 350° C., whereas electrical conductivities of 1.45×10⁴ S/cm and 4.28×10⁴ S/cm were measured after furnace heat treatment at 400° C. and 450° C., respectively. This indicates that the PVP capping agent present on the surface of the copper nanoparticles could not be combusted by 1-hour heat treatment at temperatures below 350° C., and thermal sintering could proceed only at elevated temperatures of 400° C. or higher as the capping agent was decomposed.

TABLE 2

| | | | Conductivity |
|---|---|---|---|
| Firing condition | Atmosphere | Sample | (10⁴ S/cm) |
| 1.7 W, 600 mm/sec | Air | Example 1-2 | 1.29 |
| 2.35 W, 1000 mm/sec | Air | Example 1-2 | 1.17 |
| 350° C. | Inert gas (Ar) | Example 1-4 | 0.59 |
| 400° C. | Inert gas (Ar) | Example 1-4 | 5.08 |
| 450° C. | Inert gas (Ar) | Example 1-4 | 9.65 |

Referring to Table 2, when a film fabricated using copper nanoparticles surface-functionalized with formic acid was subjected to laser heat treatment in air, high conductivities of 1.29×10⁴ S/cm and 1.17×10⁴ S/cm were measured under the high-power condition (2.35 W, 1000 mm/sec) and the low scanning speed condition (1.7 W, 600 mm/sec), respectively, where an additional oxide films was formed. This indicates that the additional oxide films generated during the laser firing process could be effectively reduced by formic acid.

In addition, when furnace heat treatment was carried out under an argon (Ar) atmosphere, an electrical conductivity of 0.59×10⁴ S/cm was measured after furnace heat treatment at 350° C., and high electrical conductivities of 5.08×10⁴ S/cm and 9.65×10⁴ S/cm were measured after furnace heat treatment at 400° C. and 450° C., respectively.

From the results of Tables 1 and 2, it can be seen that at 350° C., PVP could not be effectively thermally decomposed, but the oxide film was removed by formic acid, so that the copper nanoparticle film was partially sintered and electrical conductivity was improved. When heat treatment was performed at elevated temperatures of 400° C. and 450° C., the capping agent was thermally decomposed while the oxide film was reduced by formic acid, indicating that the copper nanoparticle film could be effectively thermally sintered.

### [Property Evaluation] Long-Term Stability Evaluation of Surface-Treated Copper Nanoparticles

The copper nanoparticles without an oxide film of Preparation Example 1 and the copper nanoparticles of Examples 1-1, 2-1 and 3-1 were stored in air for 30 days and then used to fabricate copper nanoparticle films by the same process as in Comparative Example 1-1. A laser was irradiated onto the copper nanoparticle films at a power of 1.5 W and a scanning speed of 800 mm/sec to fabricate light-irradiated patterns with a size of 1 mm×0.1 mm.

TABLE 3

Electrical conductivity (10⁴ S/cm)

| | Without storage | After 30 days |
|---|---|---|
| Sample | 1.5 W 800 mm/sec | 1.5 W, 800 mm/sec |
| Preparation | 1.17 | 0.53 (45.30%) |
| Example 1 | | |
| Example 1-1 | 1.51 | 1.42 (94.0%) |
| Example 2-1 | 1.41 | 1.31 (92.9%) |
| Example 3-1 | 1.29 | 1.10 (85.2%) |

Referring to Table 3, the copper nanoparticles of Preparation Example 1 were oxidized during 30 days of storage and exhibited low conductivity after photonic irradiation. This suggests that copper nanoparticles without surface treatment have poor long-term storage stability.

In contrast, in the case of Examples 1-1, 2-1 and 3-1 in which copper nanoparticles were surface-treated with formic acid, propionic acid, or butyric acid, the organic molecule containing carboxylic acid (formic acid, propionic acid, or butyric acid) reduced the oxide film during the photonic irradiation process even if oxidation occurred during storage. Therefore, the films obtained after photonic irradiation exhibited high conductivity, similar to films fabricated from copper nanoparticles that had not been stored for a long time. That is, copper nanoparticles surface-treated with the organic molecule containing carboxylic acid exhibit excellent long-term storage stability.

The present disclosure can provide a conductive metal film that exhibits electrical conductivity even when a metal nanoparticle film is fired in air. More specifically, the present disclosure can provide a conductive metal film that exhibits high electrical conductivity even when a firing reaction is carried out in air by using a photonic irradiation method and an organic molecule containing carboxylic acid.

In the present disclosure, the formation of an oxide film can be suppressed by the organic molecule containing carboxylic acid included in the conductive metal film, and even if an oxide film is formed, the organic molecule containing carboxylic acid can reduce the oxide film so that electrical conductivity can be restored.

In the present disclosure, even when a sufficient firing reaction does not proceed due to low power conditions or high scanning speed conditions (low delivered light energy) during a firing reaction using photonic irradiation, an additional firing reaction can occur due to the organic molecule containing carboxylic acid, so that high conductivity can be exhibited.

In the present disclosure, even when additional oxide films are generated due to high power conditions or slow scanning speed conditions (high delivered light energy) during a firing reaction using photonic irradiation, the oxide film can be reduced due to the organic molecule containing carboxylic acid, whereby the oxide film can be removed, and high conductivity can be exhibited.

The present disclosure can provide a conductive metal film that can exhibit electrical conductivity because oxide films generated during the long-term storage of metal nanoparticles in air can be removed by the organic molecule containing carboxylic acid in the heat treatment step, even when the metal nanoparticles are stored for a long time.

Although the present disclosure has been described through limited examples and drawings, the present disclosure is not intended to be limited to the examples. Those skilled in the art will appreciate that various modifications, additions and substitutions are possible, without departing from the scope and spirit of the disclosure. Therefore, the scope of the present disclosure should not be limited to the described examples, but should be defined not only by the claims described below but also by equivalents of these claims.

What is claimed is:

1. A method of fabricating a conductive metal film, the method comprising:
manufacturing a metal nanoparticle ink by mixing an organic molecule containing carboxylic acid having 1 to 17 carbon atoms in a solution in which metal nanoparticles are dispersed;
forming a metal nanoparticle film by coating the metal nanoparticle ink on a substrate; and
thermally treating the metal nanoparticle film.

2. The method according to claim 1, wherein the metal nanoparticles are bound to a capping agent, and the metal nanoparticles comprise at least one selected from the group consisting of copper, nickel, tin, iron, aluminum, molybdenum, tungsten, gallium, indium, and alloys thereof.

3. The method according to claim 2, wherein the capping agent prevents the metal nanoparticles from contacting moisture or oxygen and serves to improve dispersibility of the metal nanoparticles.

4. The method according to claim 2, wherein the capping agent is a polymer or organic molecule comprising at least one selected from the group consisting of pyridine, phosphine, phosphine oxide, amine, thiol, and hydroxyl functional groups.

5. The method according to claim 1, wherein the organic molecule containing carboxylic acid comprises 1 to 4 carboxyl groups, and is one or more selected from the group consisting of fatty acids, hydroxycarboxylic acids, amino acids, and aromatic acids.

6. The method according to claim 5, wherein the organic molecule containing carboxylic acid comprises formic acid, propionic acid, or butyric acid.

7. The method according to claim 1, wherein the thermally treating of the metal nanoparticle film is one or more selected from the group consisting of furnace heat treatment, laser irradiation heat treatment, white light irradiation heat treatment, plasma heat treatment, microwave heat treatment, and Joule heating.

8. The method according to claim 7, wherein, in the thermally treating of the metal nanoparticle film, the laser irradiation heat treatment, the white light irradiation heat treatment, the plasma heat treatment and the microwave heat treatment are performed in air.

9. The method according to claim 8, wherein the laser is irradiated at a power of 0.5 W to 20 W.

10. The method according to claim 8, wherein the laser is irradiated at a scanning speed of 100 mm/sec to 2,000 mm/sec.

11. A conductive metal film, fabricated by the method of claim 1,
wherein the conductive metal film comprises:
metal nanoparticles; and
an organic molecule containing a carboxylic acid having 1 to 17 carbon atoms, adsorbed on the metal nanoparticles,
wherein the organic molecule containing carboxylic acid prevents formation of an oxide film on the metal nanoparticles and removes the oxide film even if the oxide film is formed.

12. The conductive metal film according to claim 11, wherein the organic molecule containing carboxylic acid is adsorbed on surfaces of the metal nanoparticles.

13. The conductive metal film according to claim 11, wherein, when a conductive metal film is fabricated using the metal nanoparticles stored in air for 1 to 60 days, the conductive metal film has an electrical conductivity of 1.10×10⁴ S/cm to 9.07×10⁴ S/cm.
